(19) United States
(12) Patent Application Publication
(10) Pub. No.: US 2025/0370303 A1
(43) Pub. Date: Dec. 4, 2025

(54) LIQUID CRYSTAL DISPLAY PANEL AND LIQUID CRYSTAL DISPLAY DEVICE

(71) Applicant: WUHAN CHINA STAR OPTOELECTRONICS TECHNOLOGY CO., LTD., Wuhan, Hubei (CN)

(72) Inventor: Wei CHENG, Wuhan, Hubei (CN)

(73) Assignee: WUHAN CHINA STAR OPTOELECTRONICS TECHNOLOGY CO., LTD., Wuhan, Hubei (CN)

(21) Appl. No.: 18/870,655

(22) PCT Filed: Jun. 29, 2023
(86) PCT No.: PCT/CN2023/104257

§ 371 Date: Nov. 30, 2024

(30) Foreign Application Priority Data
Feb. 21, 2023 (CN) 202310144155.1

(51) Int. Cl. G02F 1/1345; G02F 1/1333; G02F 1/1339

(52) U.S. Cl. CPC G02F 1/13458; G02F 1/133345; G02F 1/133368; G02F 1/1339

(57) ABSTRACT

The embodiments of the present disclosure provide a liquid crystal display panel and a liquid crystal display device. In the liquid crystal display panel, at least portions of the binding terminals protrude from the sealant so that top sides of the binding terminals can be exposed, thereby contact areas between the binding terminals and the side wirings are increased. Moreover, blocking layers are disposed between portions, protruding from the sealant, of adjacent binding terminals, so that short circuits between adjacent binding terminals are avoided, and the yield of the display panel is improved.

### TECHNICAL FIELD

The present disclosure relates to the field of display technology, and in particular, to a liquid crystal display panel and a liquid crystal display device.

### BACKGROUND

TFT-LCD (thin film transistor-liquid crystal display) has been widely used due to its advantages of long lifespan, mature technology, and low price. With the development of display technology, there have been requirements for existing display devices to have narrow frames or even no frames. In order to diminish a frame of the display device, side binding technology has been used in the existing display device. Specifically, sides of the binding terminals on the array side are exposed, and the side wirings are disposed on sides of a display panel to be connected with the binding terminals. Then, the side wirings are connected to a driver chip to achieve the connection between the display panel and the driver chip. However, due to small widths of the binding terminals, contact areas between the binding terminals and the side wirings are small. Therefore, the connections between the binding terminals and the side wirings may have problems such as open circuits, which leads to failure of the connection between the display panel and the driver chip, resulting in a decrease in the yield of the display device.

Therefore, in the existing display device, there exists a technical problem of a low yield of the display device due to small contact areas between the binding terminals and the side wirings.

### SUMMARY

Embodiments of the present disclosure provide a liquid crystal display panel and a liquid crystal display device to alleviate the technical problem of a low yield of the existing display device due to the small contact areas between the binding terminals and the side wirings.

To solve the above problem, the technical solution provided in this disclosure is as follows:

Embodiments of the present disclosure provide a liquid crystal display panel including:
a first substrate including binding terminals;
a second substrate disposed opposite to the first substrate;
a liquid crystal layer disposed between the first substrate and the second substrate; and
a sealant disposed between the first substrate and the second substrate, the sealant being disposed to surround the liquid crystal layer;
wherein the liquid crystal display panel further includes blocking layers, along a direction from the liquid crystal layer to the binding terminals, at least portions of the binding terminals are arranged to extend beyond the sealant, and the blocking layers are arranged at least between portions, extending beyond the sealant, of adjacent binding terminals.

In some embodiments, the binding terminals includes first terminal portions and second terminal portions. The first terminal portions are disposed on a side of the sealant away from the second substrate, and the first terminal portions are disposed corresponding to the sealant. Along a direction from the liquid crystal layer to the binding terminals, the second terminal portions are arranged to extend beyond the sealant. The blocking layers are disposed at least between adjacent second terminal portions.

In some embodiments, the blocking layers are further disposed between adjacent first terminal portions, and portions, disposed between adjacent first terminal portions, of the blocking layers are disposed between the sealant and the first substrate.

In some embodiments, the blocking layers include first blocking portions located between adjacent first terminal portions and second blocking portions located between adjacent second terminal portions, thicknesses of the first blocking portions are less than or equal to thicknesses of the second blocking portions.

In some embodiments, sides of the second blocking portions are in contact with the first substrate, and another sides of the second blocking portions are in contact with the second substrate.

In some embodiments, lengths of the blocking layers are equal to lengths of the second terminal portions, and the sealant is filled between adjacent first terminal portions.

In some embodiments, the liquid crystal display panel further includes side wirings, the side wirings extend from a side of the liquid crystal display panel to areas where the binding terminals extend beyond the sealant and are in contact with the binding terminals.

In some embodiments, in the areas where the binding terminals extend beyond the sealant, sides of the side wirings are in contact with the binding terminals, and another sides of the side wirings are in contact with the second substrate.

In some embodiments, the blocking layers are made of one of positive photoresist and negative photoresist.

In some embodiments, projections of the binding terminals on the second substrate are non-overlapping with a projection of the sealant on the second substrate.

Further, embodiments of the present disclosure provide a liquid crystal display device including a liquid crystal display panel and a backlight module, wherein the liquid crystal display panel includes:
a first substrate including binding terminals;
a second substrate disposed opposite to the first substrate;
a liquid crystal layer disposed between the first substrate and the second substrate; and
a sealant disposed between the first substrate and the second substrate, the sealant being disposed to surround the liquid crystal layer;
wherein the liquid crystal display panel further includes blocking layers, along a direction from the liquid crystal layer to the binding terminals, at least portions of the binding terminals are arranged to extend beyond the sealant, and the blocking layers are arranged at least between portions, extending beyond the sealant, of adjacent binding terminals.

In some embodiments, the binding terminals include first terminal portions and second terminal portions. The first terminal portions are disposed on a side of the sealant away from the second substrate, and the first terminal portions are disposed corresponding to the sealant. Along a direction from the liquid crystal layer to the binding terminals, the second terminal portions are arranged to extend beyond the sealant. The blocking layers are disposed at least between adjacent second terminal portions.

In some embodiments, the blocking layers are further disposed between adjacent first terminal portions, and portions, disposed between adjacent first terminal portions, of the blocking layers are disposed between the sealant and the first substrate.

In some embodiments, the blocking layers include first blocking portions located between adjacent first terminal portions and second blocking portions located between adjacent second terminal portions, thicknesses of the first blocking portions are less than or equal to thicknesses of the second blocking portions.

In some embodiments, sides of the second blocking portions are in contact with the first substrate, and another sides of the second blocking portions are in contact with the second substrate.

In some embodiments, lengths of the blocking layers are equal to lengths of the second terminal portions, and the sealant is filled between adjacent first terminal portions.

In some embodiments, the liquid crystal display panel further includes side wirings, the side wirings extend from a side of the liquid crystal display panel to areas where the binding terminals extend beyond the sealant and are in contact with the binding terminals.

In some embodiments, in the areas where the binding terminals extend beyond the sealant, sides of the side wirings are in contact with the binding terminals, and another sides of the side wirings are in contact with the second substrate.

In some embodiments, the blocking layers are made of one of positive photoresist and negative photoresist.

In some embodiments, projections of the binding terminals on the second substrate do not overlap with a projection of the sealant on the second substrate.

### TECHNICAL EFFECTS

The embodiments of the present disclosure provide a liquid crystal display panel and a liquid crystal display device. The liquid crystal display panel includes a first substrate including binding terminals; a second substrate disposed opposite to the first substrate; a liquid crystal layer disposed between the first substrate and the second substrate; and a sealant disposed between the first substrate and the second substrate, the sealant being disposed to surround the liquid crystal layer; wherein the liquid crystal display panel further includes blocking layers, along a direction from the liquid crystal layer to the binding terminals, at least portions of the binding terminals are arranged to extend beyond the sealant, and the blocking layers are arranged at least between portions, extending beyond the sealant, of adjacent binding terminals. In this disclosure, at least portions of the binding terminals are arranged to extend beyond the sealant, so that top sides of the binding terminals can be exposed. Therefore, contact areas between the binding terminals and the side wirings can be increased, and the yield of the display panel can be improved. Meanwhile, the blocking layers are disposed between portions, extending beyond the sealant, of adjacent binding terminals, so that short circuits between adjacent binding terminals can be avoided. Moreover, the problem of short circuits between adjacent binding terminals caused by a coating for the side wirings located between adjacent binding terminals during the preparation of the side wirings can be avoided, thus the yield of the display panel can be further improved.

### BRIEF DESCRIPTION OF THE DRAWINGS

With reference to the accompanying drawings, a detailed description of the specific embodiments of the present disclosure will make the technical solutions and other beneficial effects of the present disclosure obvious.

FIG. 1 is a schematic diagram of an existing display device.

FIG. 2 is a schematic cross-sectional view of a liquid crystal display panel according to the embodiments of the present disclosure.

FIG. 3 is a first schematic diagram of a side of a liquid crystal display panel according to the embodiments of the present disclosure.

FIG. 4 is a schematic top view of a liquid crystal display panel according to the embodiments of the present disclosure.

FIG. 5 is a first schematic diagram of the side of a liquid crystal display panel according to the embodiments of the present disclosure.

FIG. 6 is a schematic diagram of a liquid crystal display device according to the embodiments of the present disclosure.

### DETAILED DESCRIPTION

A clear and complete description of the technical solutions in the embodiments of the present disclosure will be given in conjunction with the accompanying drawings in the embodiments of the present disclosure. Obviously, the described embodiments are only a part of the embodiments of the present disclosure, not all of them. Based on the embodiments in this disclosure, all other embodiments obtained by those skilled in the art without paying creative efforts are within the protection scope of this disclosure.

In the description of this disclosure, it should be understood that the terms “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “counterclockwise” and other directional or positional relationships indicated are based on the directional or positional relationships shown in the accompanying drawings, and are only for the convenience of describing this disclosure and simplifying the description, and do not indicate or imply that the device or component referred to must have a specific orientation, be constructed and operated in a specific orientation, which should not be understood as a limitation on this disclosure. In addition, the terms “first” and “second” are only used for descriptive purposes and cannot be understood as indicating or implying relative importance or implied specifying the number of technical features indicated. Thus, the features limited by “first” and “second” may explicitly or implicitly include one or more of the aforementioned features. In the description of this disclosure, the meaning of “multiple” refers to two or more, unless otherwise specifically limited.

In the description of this disclosure, it should be noted that unless otherwise specified and limited, the terms “installation”, “connection”, and “couple” should be interpreted in a broad way. For example, they can be fixed connections, detachable connections, or integral connections. It can be a mechanical connection, an electrical connection, or a communication with each other. It can be directly connected or indirectly connected through an intermediate medium. It can be a connection within two components or an interaction relationship between two components. For those of ordinary skilled in the art, the specific meanings of the above terms in this disclosure can be understood according to the specific situation.

In this disclosure, unless otherwise specified and limited, a first feature being on or below a second feature may include a direct contact between the first and second features, or may include a contact between the first and second features through another feature therebetween. Moreover, a first feature being “above”, “over”, and “on top of” a second feature includes the first feature being directly above and diagonally above the second feature, or simply indicating that the level of the first feature is higher than the second feature. A first feature being “under”, “underneath”, and “at the bottom of” a second feature includes the first feature being directly below and diagonally below the second feature, or simply indicating that the level of first feature is lower than the second feature.

The following disclosure provides many embodiments or examples to achieve various structures of the present disclosure. In order to simplify this disclosure, specific examples of components and settings are described below. Obviously, they are only examples and are not intended to limit the scope of this disclosure. In addition, same reference numbers and/or reference letters may be used in different examples for the purpose of simplification and clarity, and does not indicate the relationship between the various embodiments and/or settings discussed. In addition, the present disclosure provides examples of various specific processes and materials, but those of ordinary skilled in the art may be aware of adopting other processes and/or using other materials.

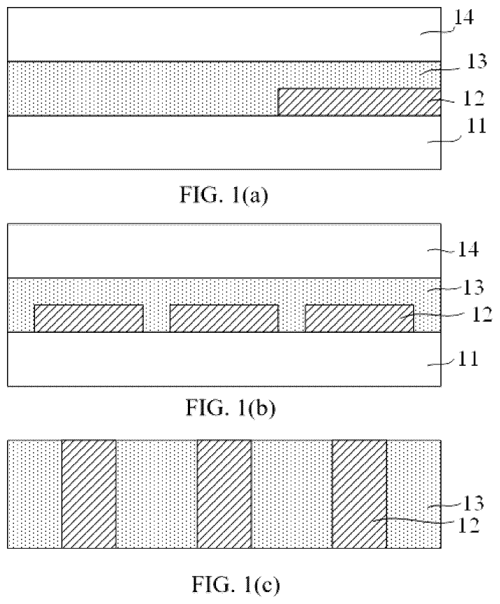

As shown in FIG. 1, (a) in FIG. 1 is a cross-sectional schematic diagram of an existing display device, (b) in FIG. 1 is a schematic diagram of a side of the existing display device, and (c) in FIG. 1 is a perspective schematic diagram of the existing display device. The existing display device includes an array substrate, a color film substrate 14, a liquid crystal layer, and a sealant 13. The array substrate includes an array layer 11 and binding terminals 12. In order to diminish a frame of the display device, sides of the binding terminals of the existing display device would be exposed, so that side wirings can be connected to the binding terminals to connect a display panel to a driver chip. However, it can be seen from FIG. 1, exposed areas of the binding terminals is the product of the widths and thicknesses of the binding terminals. In order to reduce the thicknesses and improve the resolution of the existing display device, both the widths and thicknesses of the binding terminals are made small, which results in a small exposed area of the binding terminals, and in turn leads to small contact areas between the binding terminals and the side wirings. Thus, the connections between the binding terminals and the side wirings may cause a problem such as open circuits, which in turn leads to a failure of connection between the display panel and the driver chip and a decrease in the yield of the display device. Therefore, in the existing display device, there is a technical problem of a low yield of the display device due to small contact areas between the binding terminals and the side wirings.

Given the above, the embodiments of the present disclosure provide a liquid crystal display panel and a liquid crystal display device to alleviate the above-mentioned technical problem.

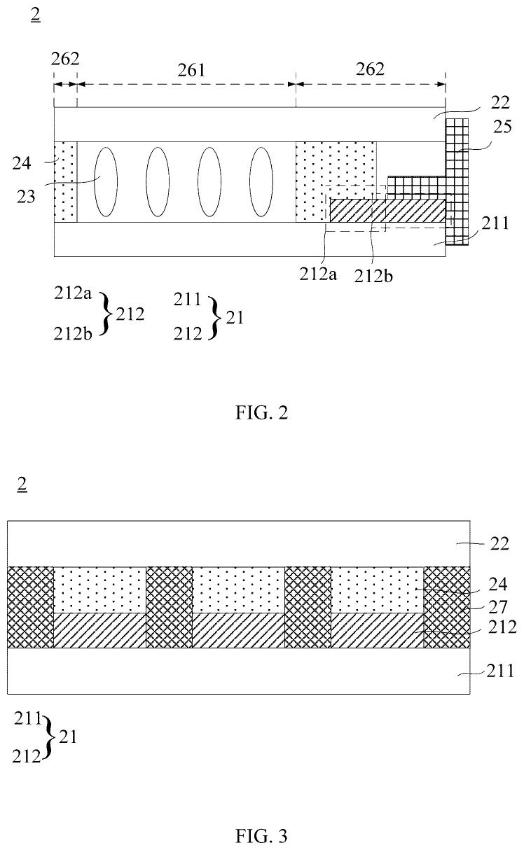

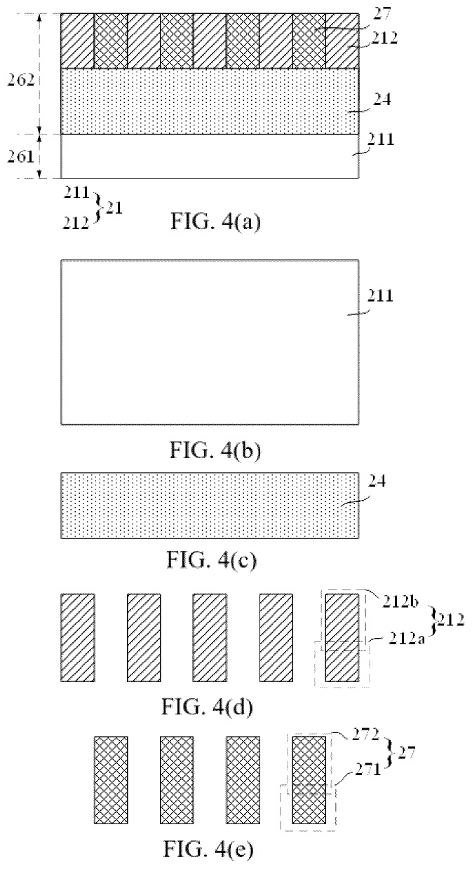

FIG. 2 is a schematic cross-sectional view of a liquid crystal display panel according to the embodiments of the present disclosure. FIG. 3 is a schematic diagram of a side of a liquid crystal display panel according to the embodiments of the present disclosure. FIG. 4 is a schematic top view of a liquid crystal display panel according to the embodiments of the present disclosure. Among them, (a) in FIG. 4 is a perspective view of each layer of a liquid crystal display panel according to the embodiments of the present disclosure, (b) in FIG. 4 is an exploded view of a first substrate of the liquid crystal display panel in (a) in FIG. 4, (c) in FIG. 4 is an exploded view of a sealant of the liquid crystal display panel in (a) in FIG. 4, (d) in FIG. 4 is an exploded view of binding terminals of the liquid crystal display panel in (a) in FIG. 4, and (e) in FIG. 4 is an exploded view of blocking layers of the liquid crystal display panel in (a) in FIG. 4.

As shown in FIG. 2 to FIG. 4, the embodiments of the present disclosure provide a liquid crystal display panel 2 including:
a first substrate 21 that includes binding terminals 212;
a second substrate 22 that is disposed opposite to the first substrate 21;
a liquid crystal layer 23 that is disposed between the first substrate 21 and the second substrate 22; and
a sealant 24 that is disposed between the first substrate 21 and the second substrate 22, and the sealant 24 is arranged to surround the liquid crystal layer 23.

Among them, the liquid crystal display panel 2 further include blocking layers 27. Along a direction from the liquid crystal layer 23 to the binding terminals 212 (e.g., a direction from left to right in FIG. 2), at least portions of the binding terminals 212 are arranged to extend beyond the sealant 24 (e.g., second terminal portions 212b in FIG. 2 are arranged to extend beyond the sealant 24), and the blocking layers 27 are disposed at least between portions, extending beyond the sealant 24, of adjacent binding terminals 212 (e.g., in FIG. 3, the blocking layers 27 are disposed between portions, extending beyond the sealant 24, of adjacent binding terminals 212).

The embodiments of the present disclosure provide a liquid crystal display panel, in which at least portions of the binding terminals extending beyond the sealant so that top sides of the binding terminals are exposed, thereby increasing the contact areas between the binding terminals and the side wirings and improving the yield of the display panel. Meanwhile, blocking layers are disposed between portions, extending beyond the sealant, of adjacent binding terminals, so that short circuits between adjacent binding terminals can be avoided. Moreover, the problem of short circuits between adjacent binding terminals caused by a coating for the side wirings located between adjacent binding terminals during the preparation of the side wirings can be avoided, thus the yield of the display panel can be further improved.

It should be noted that in the embodiments of the present disclosure, a thickness is referred to as a distance between two sides of each film layer along a direction from the first substrate to the second substrate, a length is referred to as a distance between two ends of each film layer along a direction from the liquid crystal layer to the binding terminals, and a width is referred to as a distance between two ends of each film layer from the view shown in the side view of the liquid crystal display panel. For example, a distance from a left end to a right end of one of the binding terminals 212 in FIG. 3 is the widths of the binding terminals 212.

Specifically, in the preparation process of the existing display device, after the binding terminals and the sealant are formed, a side of the existing display device is cleaned using laser technology. This can cause damage to the sealant, an uneven side of the sealant, and a phenomenon of the sealant retraction. When the side wirings are formed by coating the side, the coating is being formed between adjacent binding terminals, resulting in short circuits between adjacent binding terminals. On the other hand, the exposed area of each of the binding terminals is small, which may result in poor contacts or no contacts between the binding terminals and the side wirings. In the embodiments of the present disclosure, the binding terminals protrude from the sealant, so that the binding terminals can be connected to the side wirings at top sides besides the sides, thereby the contact areas between the binding terminals and the sides are increased and the binding yield is enhanced. Moreover, blocking layers are disposed between adjacent binding terminals, the problem of short circuits between adjacent binding terminals when the sealant retracts can be avoided. Moreover, the blocking layers can serve as a film layer that blocks water and oxygen outside the sealant, equivalent to a sealed multi-circle adhesive layer disposed outside the liquid crystal layer, thereby the ability of water-oxygen barrier is improved.

Specifically, in the formation process of existing sealant, the sealant cannot be patterned. Therefore, the embodiments of the present disclosure provide blocking layers between adjacent binding terminals for the purpose of blocking. In contrast, in the prior art, the sealant is retracted due to the limitation of the preparation process, which is different from the design of the sealant and blocking layers in the present disclosure.

Specifically, as shown in FIG. 2, the liquid crystal display panel 2 includes a display area 261 and a non display area 262, and the binding terminals 212, the sealant 24, and the blocking layers 27 are all arranged in the non display area 262.

In one embodiment, projections of the binding terminals on the second substrate do not overlap with a projection of the sealant on the second substrate. The sealant does not cover on the binding terminals, so that the exposed areas of the top sides of the binding terminals are increased, and the contact areas between the binding terminals and the side wirings are increased, thereby improving the bonding yields between the binding terminals and the side wirings, and enhancing the yield of the liquid crystal display panel.

Specifically, to address the problem of a large side frame of the liquid crystal display panel when the sealant does not cover on the binding terminals, the lengths of the binding terminals can be reduced so that the side frame of the liquid crystal display panel can be made smaller. However, the embodiments of the present disclosure are not limited thereto. For example, the lengths of the binding terminals may not be reduced, and thus the contact areas between the binding terminals and the side wirings may be increased which improves the bonding yields between the binding terminals and the side wirings and improves the yield of the liquid crystal display panel.

In one embodiment, as shown in FIG. 2 to FIG. 4, the binding terminals 212 include first terminal portions 212a and second terminal portions 212b. The first terminal portions 212a are disposed on a side of the sealant 24 away from the second substrate 22, and the first terminal portions 212a are disposed corresponding to the sealant 24. Along a direction from the liquid crystal layer 23 to the binding terminals 212, the second terminal portions 212b protrude from the sealant 24, and the blocking layers 27 are disposed at least between adjacent second terminal portions 212b. The binding terminals include first terminal portions and second terminal portions and the sealant is disposed on the first terminal portions, so that the length of the sealant is made large, which provides a better protection to and support for the liquid crystal layer by the sealant. The second terminal portions protrude from the sealant, allowing both the side and top sides of the second terminal portions to be connected to the side wirings, thereby the bonding yield between the binding terminals and the side wirings is improved. The blocking layers are disposed between adjacent second terminal portions, so that short circuits between adjacent binding terminals can be avoided and the yield of the liquid crystal display panel can be improved.

Specifically, in order to improve a binding effect of the binding terminals and reduce the difficulty of the process, the lengths of the binding terminals may be made long in the process of disposing the binding terminals and the sealant. Therefore, the sealant can be made to cover portions of the binding terminals and have a long length, which can provide a better protection to the liquid crystal layer. At the same time, the width of the side frame of the liquid crystal display panel can be reduced, and the side frame of the liquid crystal display panel is reduced.

Specifically, the blocking layers are arranged between the second terminal portions so that adjacent binding terminals are separated by the blocking layers. When the binding terminals are connected to the side wirings, the blocking layers can avoid short circuits between adjacent binding terminals, irrespective of whether a conductive adhesive is used to connect the binding terminals to the side wirings or the binding terminals are directly connected to the side wirings, thereby the bonding yield between the binding terminals and the side wirings are improved.

In one embodiment, as shown in FIG. 4, the blocking layers 27 are further arranged between adjacent first terminal portions 212a, and portions of the blocking layers 27 that disposed between adjacent first terminal portions 212a are disposed between the sealant 24 and the first substrate 21. The blocking layers are disposed between adjacent first terminal portions, short circuits between adjacent binding terminals can be avoided. The portions of the blocking layers between adjacent first terminal portions are arranged between the sealant and the first substrate, so that the length of the sealant is made large, thereby the liquid crystal layer can be protected by the sealant and the yield of the liquid crystal display panel can be improved.

Specifically, when the blocking layers are formed, the portions, disposed between adjacent first terminal portions, of the blocking layers are disposed between the sealant and the first substrate. Therefore, when the sealant is being formed, the sealant, as a whole, can be arranged on the blocking layers and the first terminal portion, so that the liquid crystal layer is protected.

In one embodiment, as shown in FIG. 4, the blocking layers 27 include first blocking portions 271 located between adjacent first terminal portions 212a, and second blocking portions 272 located between adjacent second terminal portions 212b. Thicknesses of the first blocking portions 271 are less than or equal to those of the second blocking portions 272. The thicknesses of the first blocking portions are smaller than those of the second blocking portions, so that the second blocking portions can serve as a supplement to the sealant. In case that the liquid crystal display panel is being squeezed, the second blocking portions can assist the sealant in supporting the liquid crystal layer, avoiding damage to the liquid crystal layer under pressure and improving the ability of squeeze resistance of the liquid crystal display panel. The thicknesses of the first blocking portions are equal to the thicknesses of the second blocking portions, so that the blocking layers can be formed as an entire side when the blocking layers are formed, without the need to etch each part of the blocking layers separately or multiple times, thus improving the preparation efficiency of the liquid crystal display panel.

Specifically, when the blocking layers are formed, the thickness of each portion of the blocking layers is made to be equal, so that there is no need to etch each part of the blocking layers separately or etch the blocking layers multiple times for forming first and second blocking portions with different thicknesses. After the blocking are is formed, it can be patterned directly, thereby the preparation efficiency of the liquid crystal display panel is improved.

In one embodiment, sides of the second blocking portions are in contact with the first substrate, and another sides of the second blocking portions are in contact with the second substrate. Both sides of the second blocking portions are in contact with the first substrate and the second substrate respectively, so that the liquid crystal layer can be supported by the second blocking portion. In the areas where the binding terminals are not covered by the sealant, the liquid crystal layer can be supported by the second blocking portions which sever as a substitute to the sealant, so that the collapse and failure of the liquid crystal layer when it is extruded or pressed by the liquid crystal display panel can be avoided, thereby the ability of squeeze resistance of the liquid crystal display panel can be improved. Moreover, the second blocking portions and the sealant act as an equivalent to a sealed multi-circle adhesive layer, which improves the ability of water-oxygen barrier of the liquid crystal display panel.

Specifically, as shown in FIG. 3, in case that the blocking layers 27 include first blocking portions and second blocking portions, both sides of the second blocking portions can be in contact with the first substrate and the second substrate respectively. In the schematic side view of the liquid crystal display panel, the blocking layers 27 are in contact with the first substrate and the second substrate respectively, thereby supporting the liquid crystal layer and improving the ability of squeeze resistance of the liquid crystal display panel. The second blocking portions and the sealant act as an equivalent to a sealed multi-circle adhesive layer, which improves the ability of water-oxygen barrier of the liquid crystal display panel.

Specifically, in FIG. 2 to FIG. 4, the first substrate 21 is shown with a first base 211 and the bonding terminals 212. However, it can be understood that the first substrate 21 includes a thin film transistor array layer. In case that the second blocking portions come into contact with the first substrate, it comes into contact with a passivation layer or a flat layer of the first substrate closest to the liquid crystal layer.

Specifically, the above embodiments are illustrated by an example in which the second blocking portions are in contact with the first substrate and the second substrate on both sides, but the embodiments of the present disclosure are not limited thereto. For example, in case that the blocking layers are only disposed between the second terminal portions, both sides of the blocking layers may be in contact with the first substrate and the second substrate respectively.

Specifically, the above embodiments describe an example that the second blocking portions are in contact with the first substrate and the second substrate on both sides, but the embodiments of the subject application are not limited thereto. For example, sides of the second blocking portions re in contact with the first substrate, and there is a certain spacing between another sides of the second blocking portions and the second substrate, so that the squeeze of the second blocking portions to the first and second substrates due to excessive thicknesses of the second blocking portions can be avoided, thereby improving the yield of the liquid crystal display panel.

In one embodiment, lengths of the blocking layers are equal to lengths of the second terminal portions, and the sealant is filled between adjacent first terminal portions. The lengths of the blocking layers are made equal to the lengths of the second terminal portions and the sealant is filled between adjacent first terminal portions, so that the length of each portion of the sealant can be made large, resulting in a better sealing effect on the liquid crystal layer and an improved yield of the liquid crystal display panel.

Here is toward a problem of poor contact or no contact caused by small contact areas between the binding terminals and the side wirings, which leads to a lower yield of the liquid crystal display panel. In one embodiment, as shown in FIG. 2, the liquid crystal display panel 2 further includes side wirings 25, which extend from the side of the liquid crystal display panel 2 to areas where the binding terminals 212 protrude from the sealant 24, and is in contact with the binding terminals 212. The side wirings are extended to the areas where the binding terminals protrude from the sealant, so that the side wirings come into contact with the side and top sides of the binding terminals, increasing the contact areas between the binding terminals and the side wirings and improving the yield of the liquid crystal display panel.

Specifically, as shown in FIG. 2, it can be seen that the side wirings 25 are in contact with the first substrate 21 and the second substrate 22 respectively on the side of the liquid crystal display panel. The side wirings 25 are connected to the side of the binding terminals 212, and are also connected to the top sides of the second terminal portions 212b. Therefore, the contact areas between the side wirings 25 and the binding terminals 212 are equal to a sum of an area of sides of the binding terminals 212 and an area of the top side of the second terminal portions 212b of the binding terminals 212. Compared with the existing liquid crystal display device, the contact areas between the binding terminals and the side wirings are increased, which improves the yield of the liquid crystal display panel.

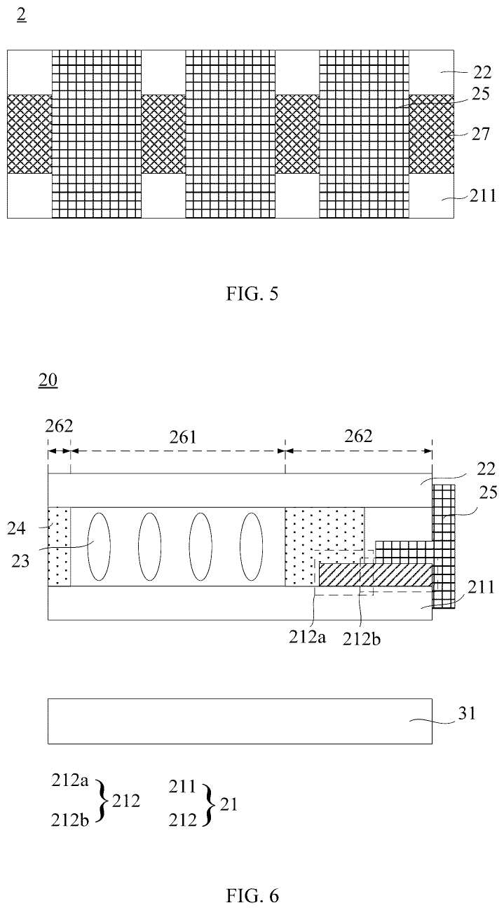

Specifically, as shown in FIG. 1 to FIG. 5, a comparison is made between the contact areas between the binding terminals and the side wirings in the existing display device and the contact area of the liquid crystal display panel of the present disclosure. As shown in FIG. 1, in the existing display device, the binding terminals 12 are covered by the sealant 13, so that the side wirings only come into contact with the sides of the binding terminals 12. Taking the width of a single binding terminal as 30 microns and the thickness as 2000 angstroms as an example. In the existing display device, the contact area between a single binding terminal and the side wiring is 6 square microns. Taking the lengths of the portions of the bonding terminals that protrude from the sealant as 30 microns, the width of a single bonding terminal as 30 microns and the thickness as 2000 angstroms as an example. As shown in FIG. 2 and FIG. 5, in the liquid crystal display panel provided in the embodiments of the present disclosure, it can be seen that the side wirings 25 come into contact with not only the sides of the bonding terminals 212, but also with the top sides of the bonding terminals 212. Therefore, in the embodiments of the present disclosure, the contact area between a single bonding terminal and the side wiring is the sum of the contact area between a singe side wiring and the side of the bonding terminal and the contact area between the side wiring and the top side of the bonding terminal, which is 6 square microns+30 microns*30 microns, i.e., 906 microns. In the embodiment of the present disclosure, the contact area between a single binding terminal and the side wiring is over 100 times the contact area of a single binding terminal and the side wiring in the existing display device. Therefore, the contact area between the binding terminal and the side wiring is increased, and the yield of the liquid crystal display panel is improved.

Here is toward a problem of gaps on the binding terminals that may lead to water and oxygen invasion. In one embodiment, in the areas where the binding terminals protrude from the sealant, sides of the side wirings are in contact with the binding terminals, and another sides of the side wirings are in contact with the second substrate. The sides of the side wirings are in contact with the binding terminals and another sides of the side wirings are in contact with the second substrate, so that the gap on the binding terminals can be filled with the side wirings to avoid water and oxygen invasion caused by the gaps on the binding terminals. In addition, the increased thicknesses of the side wirings cause the impedance of the side wirings to be small and thus reduces the impedance of the side wirings.

Specifically, in case that the binding terminals are connected to the side wirings, when sides of the side wirings contact the binding terminals and another sides contact the second substrate, the gaps on the binding terminals can be filled by the side wirings, thereby the ability of water-oxygen barrier of the liquid crystal display panel can be improved. Moreover, the increased thicknesses of the side wirings can improve the electrical performance of the side wirings.

Specifically, thicknesses of portions of the side wirings located in areas where the binding terminals protrude from the sealant is increased, so that the thicknesses of the portions of the side wirings located in the areas where the binding terminals protrude from the sealant can be made equal to thicknesses of portions of the side wirings located on a side of the liquid crystal display panel. However, the embodiments of the present disclosure are not limited thereto. For example, in order to reduce the side frame of the liquid crystal display panel, the thicknesses of the portions of the side wirings located on the side of the liquid crystal display panel can be made smaller than the thicknesses of the portions of the side wirings located in the areas where the binding terminals protrude from the sealant, thereby reducing the side frame of the liquid crystal display panel.

In one embodiment, the blocking layers are made of one of positive photoresist and negative photoresist. The blocking layers are made of one of positive photoresist and negative photoresist, so that the photoresist can be removed simply by exposure and development during the formation of the blocking layers, avoiding impacts on other film layers of the liquid crystal display panel and improving the yield of the liquid crystal display panel.

Specifically, when forming the blocking layers, in order to avoid damages to the bonding terminals or other film layers in the liquid crystal display panel in the process of etching, a photoresist can be used to form the blocking layers. The materials used to form the blocking layers are exposed and developed, so that adjacent bonding terminals can be separated by the blocking layers and short circuits between adjacent bonding terminals can be avoided.

Specifically, since the sealant cannot be patterned between portions, protruding from the sealant, of adjacent bonding terminals, this embodiment of the present disclosure provides the blocking layers that can be arranged between portions, protruding from the sealant, of adjacent bonding terminals, avoiding short circuits between adjacent bonding terminals caused by coating or conductive adhesive being placed between adjacent bonding terminals during the formation of the side wirings. The photoresist is used to form the blocking layers, which can avoid damages to other film layers in the liquid crystal display panel and improve the yield of the liquid crystal display panel.

Specifically, the above embodiments are specified by taking the photoresist as the material of the blocking layers, but the embodiments of the present disclosure are not limited thereto. Other materials that can be patterned and insulated, including organic and inorganic materials, can also be used as the material of the blocking layers.

Meanwhile, the present embodiments provide a liquid crystal display device including a liquid crystal display panel as described in any of the above embodiments and a backlight module.

Specifically, as shown in FIG. 6, a liquid crystal display device 20 includes a backlight module 31 disposed on a side of the liquid crystal display panel.

Specifically, the liquid crystal display device also includes a driving chip, which is connected to the connection wiring.

According to the above embodiments, it is clear that:

The embodiments of the present disclosure provide a liquid crystal display panel and a liquid crystal display device. The liquid crystal display panel includes a first substrate, a second substrate, a liquid crystal layer, and a sealant. The first substrate includes binding terminals, and the second substrate is arranged opposite to the first substrate. The liquid crystal layer is arranged between the first substrate and the second substrate. The sealant is arranged between the first substrate and the second substrate and around the liquid crystal layer. The liquid crystal display panel also includes blocking layers. Along a direction from the liquid crystal layer to the binding terminals, at least portions of the binding terminals protrude from the sealant, and the blocking layers are at least arranged between portions, protruding from the sealant, of adjacent binding terminals. In this disclosure, at least portions of the binding terminals protrude from the sealant so that top sides of the binding terminals can be exposed. Therefore, the contact areas between the binding terminals and the side wirings can be increased and the yield of the display panel can be improved. At the same time, the blocking layers are disposed between portions, protruding from the sealant, of adjacent binding terminals, so that short circuits between adjacent binding terminals can be avoided. Moreover, the problem of short circuits between adjacent binding terminals caused by a coating for the side wirings located between adjacent binding terminals in the preparation for the side wirings can be avoided, thus the yield of the display panel can be further improved.

In the above embodiments, different parts of the technical solution are given different levels of description in different embodiment, and some features that are not specified in a particular embodiment can be found in the relevant descriptions of other embodiments.

The above provides a detailed description to a liquid crystal display panel and liquid crystal display device provided in the embodiments of the present disclosure. Specific examples are applied in this specification to explain the principles and implementation methods of the present disclosure. The above embodiments are only used to help understand the technical solution and core idea of the present disclosure; Ordinary skilled in the art should understand that they can modify the technical solutions described in the aforementioned embodiments, or equivalently replace some of the technical features, which do not deviate from the essence of the corresponding technical solutions from the scope of the technical solutions of the various embodiments of the present disclosure.

1. A liquid crystal display panel, comprising:
a first substrate comprising binding terminals;
a second substrate disposed opposite to the first substrate;
a liquid crystal layer disposed between the first substrate and the second substrate; and
a sealant disposed between the first substrate and the second substrate, the sealant being disposed to surround the liquid crystal layer;
wherein, the liquid crystal display panel further comprises blocking layers, along a direction from the liquid crystal layer to the binding terminals, at least portions of the binding terminals are arranged to extend beyond the sealant, and the blocking layers are arranged at least between portions, extending beyond the sealant, of adjacent binding terminals.

2. The liquid crystal display panel according to claim 1, wherein
the binding terminals comprise first terminal portions and second terminal portions;
the first terminal portions are disposed on a side of the sealant away from the second substrate, and the first terminal portions are disposed corresponding to the sealant; and
along the direction from the liquid crystal layer to the binding terminals, the second terminal portions are arranged to extend beyond the sealant, the blocking layers are disposed at least between adjacent second terminal portions.

3. The liquid crystal display panel according to claim 2, wherein the blocking layers are further disposed between adjacent first terminal portions, and portions, disposed between adjacent first terminal portions, of the blocking layers are disposed between the sealant and the first substrate.

4. The liquid crystal display panel according to claim 3, wherein the blocking layers comprise first blocking portions located between adjacent first terminal portions and second blocking portions located between adjacent second terminal portions, a thickness of each of the first blocking portions is less than or equal to a thickness of each of the second blocking portions.

5. The liquid crystal display panel according to claim 4, wherein a side of the second blocking portions are in contact with the first substrate, and another sides of the second blocking portions are in contact with the second substrate.

6. The liquid crystal display panel according to claim 2, wherein a length of each of the blocking layers is equal to a length of each of the second terminal portions, and the sealant is filled between adjacent first terminal portions.

7. The liquid crystal display panel according to claim 1, wherein the liquid crystal display panel further comprises side wirings, the side wirings extend from a side of the liquid crystal display panel to areas where the binding terminals extend beyond the sealant and are in contact with the binding terminals.

8. The liquid crystal display panel according to claim 7, wherein in the areas where the binding terminals extend beyond the sealant, sides of the side wirings are in contact with the binding terminals, and another sides of the side wirings are in contact with the second substrate.

9. The liquid crystal display panel according to claim 1, wherein the blocking layers are made of one of positive photoresist and negative photoresist.

10. The liquid crystal display panel according to claim 1, wherein projections of the binding terminals on the second substrate are non-overlapping with a projection of the sealant on the second substrate.

11. A liquid crystal display device, comprising a liquid crystal display panel and a backlight module, wherein the liquid crystal display panel comprises:
a first substrate including binding terminals;
a second substrate disposed opposite to the first substrate;
a liquid crystal layer disposed between the first substrate and the second substrate; and
a sealant disposed between the first substrate and the second substrate, the sealant being disposed to surround the liquid crystal layer;
wherein the liquid crystal display panel further comprises blocking layers, along a direction from the liquid crystal layer to the binding terminals, at least portions of the binding terminals are arranged to extend beyond the sealant, and the blocking layers are arranged at least between portions, extending beyond the sealant, of adjacent binding terminals.

12. The liquid crystal display device according to claim 11, wherein
the binding terminals comprise first terminal portions and second terminal portions;
the first terminal portions are disposed on a side of the sealant away from the second substrate, and the first terminal portions are disposed corresponding to the sealant; and
along the direction from the liquid crystal layer to the binding terminals, the second terminal portions are arranged to extend beyond the sealant, the blocking layers are disposed at least between adjacent second terminal portions.

13. The liquid crystal display device according to claim 12, wherein the blocking layers are further disposed between adjacent first terminal portions, and portions, disposed between adjacent first terminal portions, of the blocking layers are disposed between the sealant and the first substrate.

14. The liquid crystal display device according to claim 13, wherein the blocking layers comprise first blocking portions located between adjacent first terminal portions and second blocking portions located between adjacent second terminal portions, a thickness of each of the first blocking portions is less than or equal to a thickness of each of the second blocking portions.

15. The liquid crystal display device according to claim 14, wherein sides of the second blocking portions are in contact with the first substrate, and another sides of the second blocking portions are in contact with the second substrate.

16. The liquid crystal display device according to claim 12, wherein a length of each of the blocking layers is equal to a length of each of the second terminal portions, and the sealant is filled between adjacent first terminal portions.

17. The liquid crystal display device according to claim 11, wherein the liquid crystal display panel further comprises side wirings, the side wirings extend from a side of the liquid crystal display panel to areas where the binding terminals extend beyond the sealant and are in contact with the binding terminals.

18. The liquid crystal display device according to claim 17, wherein in the areas where the binding terminals extend beyond the sealant, sides of the side wirings are in contact with the binding terminals, and another sides of the side wirings are in contact with the second substrate.

19. The liquid crystal display device according to claim 11, wherein the blocking layers are made of one of positive photoresist and negative photoresist.

20. The liquid crystal display device according to claim 11, wherein projections of the binding terminals on the second substrate are non-overlapping with a projection of the sealant on the second substrate.
